(19) United States
(12) Patent Application Publication
(10) Pub. No.: US 2025/0002245 A1
(43) Pub. Date: Jan. 2, 2025

(54) Single-serve capsule for preparing a beverage using a beverage-preparation machine, beverage-preparation system, and method for producing a single-serve capsule

(71) Applicant: K-FEE SYSTEM GMBH, Bergisch Gladbach (DE)

(72) Inventors: Marc Krüger, Bergisch Gladbach (DE); Günter Empl, Bergisch Gladbach (DE)

(21) Appl. No.: 18/822,537

(22) Filed: Sep. 3, 2024

Related U.S. Application Data
(63) Continuation of application No. 18/730,428, filed on Jan. 1, 0001.

(30) Foreign Application Priority Data
Feb. 11, 2022 (DE) 10 2022 201 481.2

(51) Int. Cl. B65D 85/804; A47J 31/40; A47J 31/44

(52) U.S. Cl. CPC B65D 85/8058; A47J 31/407; A47J 31/4492

(57) ABSTRACT

A single-serve capsule for preparing a beverage with a beverage preparation machine, the single-serve capsule having a base element with a cavity for receiving a beverage raw material, and a lid element closing the cavity, the base element comprising a bottom region, an encircling flange at an end opposite the bottom region and a capsule wall extending from the bottom region to the encircling flange, the single-serve capsule has an optically detectable identification code, or a bit code and/or a barcode, the optically detectable identification code is arranged on the lid element, the lid element protrudes beyond the flange, the lid element is rigid at least in regions and/or partially where the optically detectable identification code is provided on the partially rigid lid element outside of the flange.

### CROSS REFERENCE TO RELATED APPLICATIONS

This application is a continuation of U.S. Ser. No. 18/730,428 filed on Jul. 19, 2024, which is a US National Stage Entry of PCT/EP2023/050895 filed on Jan. 16, 2023, which claims priority to DE 10 2022 201 481.2 filed on Feb. 11, 2022, all of which are hereby incorporated by reference herein in their entireties for all purposes.

### FIELD

The present invention is based on a single-serve capsule for preparing a beverage by means of a beverage preparation machine, the single-serve capsule having a base element with a cavity for receiving a beverage raw material, and a lid element closing the cavity, the base element comprising a bottom region, an encircling flange at the end opposite the bottom region and a capsule wall extending from the bottom region to the encircling flange, wherein the single-serve capsule has an optically detectable identification code, in particular a bit code and/or barcode.

### BACKGROUND

Such single-serve capsules are known from the prior art. For example, the document WO 2016/186488 A1 discloses a single-serve capsule of the type in question. This single-serve capsule is provided for being inserted into a brewing chamber, in which the single-serve capsule is perforated in order to introduce liquid in the form of hot water under pressure into the cavity. By interaction between the introduced water and the beverage raw material, in particular roasted and ground coffee, a beverage is produced which leaves the single-serve capsule through further perforation locations and enters a vessel.

For each single-serve capsule, there is generally an appropriate beverage preparation machine which is optimized for the preparation of beverages based on the appropriate single-serve capsules. In order to avoid malfunctions, it has proven successful to provide such single-serve capsules with detectable identification codes which are machine-readable and optically readable, and therefore, before the beginning of the brewing process, it can be checked whether the inserted single-serve capsule is compatible with the machine. In addition, a suitable brewing program for the beverage raw material located in the single-serve capsule may be started, if appropriate.

Documents EP 3023362 B1, WO 2020/201487 A1 and U.S. Pat. No. 10,800,600 B2 disclose printing such optical detectable features in the form of barcodes or binary codes on the flange of the capsule.

In the case of the known single-serve capsules, the lid element is connected to the flange in an integrally bonded manner, in particular sealed, during production. However, this may result in an adverse structural effect on the flange. The result is that either an already applied identification code is damaged or subsequent application of the identification code is made more difficult.

### SUMMARY

It is an object of the present invention to provide a single-serve capsule with an optically detectable identification code, which represents an improvement compared to the solutions known from the cited prior art. In particular, the identification code is intended to be applied without error and simply to the single-serve capsule during the production of the single-serve capsule. In addition, it is desirable to develop the known single-serve capsules in such a way that the reading of the identification code in the beverage preparation machine is more reliable.

The object of the present invention is achieved with a single-serve capsule as claimed in claim 1.

Advantageous refinements and developments of the invention can be found in the dependent claims and in the description below with reference to the drawings.

The advantages explained relating to this subject matter of the present invention and the associated embodiments also apply mutatis mutandis to the other subject matter of the present invention and vice versa.

A single-serve capsule for preparing a beverage by means of a beverage preparation machine is proposed, the single-serve capsule having a base element with a cavity for receiving a beverage raw material, and a lid element closing the cavity, the base element comprising a bottom region, an encircling flange at the end opposite the bottom region and a capsule wall extending from the bottom region to the encircling flange, wherein the single-serve capsule has an optically detectable identification code, in particular a bit code and/or barcode.

The single-serve capsule according to the invention is now provided in such a way that either the optically detectable identification code is arranged on the side of the flange facing the bottom region, or that the lid element is fastened to the flange.

The single-serve capsule according to the invention has the advantage over the single-serve capsules known from the prior art that the identification code is not provided on the flange if the lid element is fastened thereto. This eliminates a possible source of error during the production and/or the use of the capsule. In particular, the identification code may be provided on the flange, but then the lid element is connected to the base element in some other way, or the lid element is fastened to the flange, but then the identification code is provided on an element other than the flange.

Preferably, the identification code is always provided on a side facing the bottom region. This position is also referred to in the context of the present invention as the underside of the flange or the underside. This refers to an orientation of the single-serve capsule, which rests with the bottom region on a surface and the lid element is aligned in a horizontal plane. Of course, the single-serve capsule may, for example, rest flat with the lid element on the surface; in this case, the designations then apply mutatis mutandis.

Preferably, the optically detectable identification code is printed or inscribed. The lid element is particularly preferably connected to the base element, in particular to the flange, in an integrally bonded manner, for example glued or sealed.

According to a preferred embodiment of the present invention, it is provided that the lid element is fastened to the capsule wall, in particular to the inside of the capsule wall. The lid element may, for example, be inserted somewhat into the cavity via a sonotrode and connected there laterally to the capsule wall in an integrally bonded manner. The lid element is particularly preferably connected to the capsule wall from the inside. Alternatively or additionally, the lid element is connected to the capsule wall from the outside. For example, sealing can be carried out with simultaneous pressing on from the outside and/or inside. Very particularly preferably, a fastening region is provided above and/or below a main plane of extent of the lid element. Even more preferably, the main plane of extent of the lid element is aligned flush with the main plane of extent of the flange. This makes it possible, in an advantageous way, for the lid element not to be fastened to the flange, and therefore the identification code can be affixed to the latter in turn, in particular on the underside of the flange, without the identification code being able to be damaged or an erroneous detection being able to occur during the production of the single-serve capsule and/or the use in a beverage preparation machine. A fastening to the inside of the capsule wall, with the fastening region being arranged below the main plane of extent and with the lid element and flange being flush, is particularly advantageous since it is excluded in this case that, during the use of the single-serve capsule, the lid element is not pierced as the piercing means of the beverage preparation machine do not reach far enough into the single-serve capsule.

According to a preferred embodiment of the present invention, it is provided that the lid element is an elastic lid film and/or comprises a material reservoir, wherein the lid element is designed in such a manner that it bulges outward because of outgassing of the beverage raw material. In particular, a material reservoir means that, in the fastened state, the lid element is not under tension, but can bulge outward under the pressure of the gas formed in the cavity of the single-serve capsule, for example carbon dioxide in the case of roasted coffee as a beverage raw material. A person skilled in the art understands that, in this case, the lid element is shaped convexly in cross section for a predetermined time after the closure of the cavity containing the beverage raw material. This makes it possible in a particularly advantageous manner that a technically simpler fastening to the inner wall of the capsule, that is, to the inside of the capsule wall, is carried out, wherein a fastening region is arranged above the main plane of extent of the lid element but, because of the bulging of the lid element, said fastening region nevertheless lies at least in a central piercing region, preferably also in an outer, peripheral piercing region, at least approximately on the plane of the flange, and thus reliable piercing is ensured.

According to a preferred embodiment of the present invention or according to further subject matter of the present invention, it is provided that the lid element comprises an, in particular encircling, annular element. The lid element may be provided in one piece or multiple pieces. Preferably, the annular element is provided separately from the rest of the lid element, for example a lid film, and is connected thereto in a form-fitting, force-fitting and/or integrally bonded manner. Alternatively, the annular element is designed as a local and circumferential thickened portion, in particular in a constant radius around a central axis of the single-serve capsule.

Particularly preferably, the annular element is arranged at a radially outer end of the lid element. Alternatively, the lid element also extends radially outside the annular element by a predetermined distance. The annular element is very particularly preferably connected in a fastening region to the base element, in particular to the flange. Preferably, the annular element is fastened to the flange. Even more preferably, the annular element is manufactured at least in the fastening region from an at least partially different material from the rest of the lid element. In particular, the annular element is softer and/or more deformable at least in the fastening region. This makes it possible in a particularly advantageous manner for the lid element to be fastenable indirectly via the annular element at a usual position on the flange, but damage to and/or an adverse effect on the identification code are/is avoided by virtue of the shape and/or the material properties of the annular element.

According to a preferred embodiment of the present invention, it is provided that the optically detectable identification code is arranged on the annular element. Particularly preferably, the lid element is fastened to the flange radially within the annular element. In this case, the flange is very particularly preferably shorter, i.e. has a smaller width in the radial direction, and therefore the identification code is arranged at a suitable location for detection in the beverage preparation machine. This makes it advantageously possible to fasten the lid element to the flange in the usual manner, without having an adverse effect on the identification code which is now arranged on the annular element. The annular element may have any suitable cross section, such as a rectangular, square, round or elliptical cross section.

According to a preferred embodiment of the present invention, it is provided that the lid element projects beyond the flange. Preferably, the identification code is provided on the lid element. This makes it advantageously possible for the identification code to be provided on the lid element, as a result of which an adverse effect on the identification code when fastening the lid element to the flange can be avoided.

According to a preferred embodiment of the present invention, it is provided that the lid element is at least partially constructed around the flange. For example, the lid element is provided with a larger diameter than the diameter of the base element, in particular the flange, and optionally is firstly fastened to the flange and then folded over, or first folded over and then fastened to the flange. The identification code is preferably provided on the lid element in such a way that the identification code is arranged on the underside of the flange and facing the bottom region after the production of the single-serve capsule. Preferably, the lid element is fastened at least to the top side of the flange. This makes it advantageously possible not to provide the identification code on the flange, but for the identification code to nevertheless be arranged at the usual position.

According to a preferred embodiment of the present invention, it is provided that the optically detectable identification code is arranged on the lid element, in particular on a side facing the bottom region. This advantageously ensures that, although the identification code is not provided on the flange, it is nevertheless arranged in the usual position.

According to a preferred embodiment of the present invention, it is provided that the single-serve capsule has in the region of the flange an enclosure element which at least partially surrounds the flange and/or the lid element, wherein the enclosure element preferably extends uninterrupted on both sides of the flange, wherein preferably the optically detectable identification code is arranged on the enclosure element. Particularly preferably, the enclosure element comprises a shrinkable plastics material. Very particularly preferably, the enclosure element is provided in a substantially U-shaped manner. Preferably, the enclosure element is guided from the outside over the flange and lid element and then fixed. It is known to shrink and fix shrink films made from plastic by applying heat. Particularly preferably, the lid element and the flange are fixed in their position relative to each other by the enclosure element. This enables the lid element and the flange to be indirectly connected to each other in an advantageous manner. Preferably, the enclosure element is substantially transparent, at least on the underside of the flange. Particularly preferably, the identification code is provided on the enclosure element.

According to a preferred embodiment of the present invention, it is provided that the flange and the lid element are connected to each other by the enclosure element. This makes it advantageously possible to connect the flange and the lid element to each other without having an adverse effect on them structurally due to a direct action of force.

According to a preferred embodiment of the present invention, it is provided that the lid element is a substantially flexible lid film and/or a lid element which is rigid at least in certain regions and/or is partially rigid, wherein the optically detectable identification code is preferably provided on the partially rigid lid element radially outside the flange and in particular on the side of the lid element facing the bottom region. Preferably, the lid element is provided with one or more layers. In the case of a rigid lid element, the lid element is provided in such a way that piercing of the lid element by piercing means of the beverage preparation machine is possible in a central piercing region and/or an outer piercing region. This can be undertaken, for example, by way of a suitable selection of material. Particularly preferably, the lid element is substantially manufactured from one material over its entire extent, or the lid element is at least partially manufactured from different materials in different regions. Preferably, a rigid lid element means that the lid element has sufficient intrinsic stability, and therefore a region protruding beyond the flange maintains a substantially horizontal orientation. At the same time, the lid element is flexible enough, in particular at least in the piercing regions, that piercing is carried out safely and without damage being caused to the beverage preparation machine, in particular the piercing means. Particularly preferably, the identification code is provided in a region projecting beyond the flange. This makes it advantageously possible for the identification code not to have to be provided on the flange, as a result of which the lid element can be fastened to the flange in the usual manner.

According to a preferred embodiment of the present invention, it is provided that the single-serve capsule is formed rotationally symmetrically about a central axis running centrally through the single-serve capsule. This is particularly advantageous for beverage preparation by centrifugation of the single-serve capsule.

According to a preferred embodiment of the present invention, it is provided that the flange has a crimping and in particular a rolled edge at its radially outer end.

According to a preferred embodiment of the present invention, it is provided that the identification code comprises in particular a bit code and/or barcode, the coding strokes of which run in particular in the radial direction. Preferably, the coding strokes comprise white and/or black bars of equal or unequal thickness along a circumferential direction (concentrically about the central axis). Particularly preferably, it is provided that the identification code is provided along the entire circumference or only in certain regions. Very particularly preferably, the identification code is provided repeatedly along the circumference in predetermined and in particular uniformly mutually spaced regions.

According to a preferred embodiment of the present invention, it is provided that the base element is manufactured from plastic. Preferably, the base element is produced by cold or hot deformation, in particular deep drawing. The configuration of the base element with a cavity is preferably produced by thermoforming, for example deep drawing by means of negative pressure, positive pressure and/or a movable die. Alternatively, the single-serve capsule is produced by means of an injection molding process, in particular in a one-component, multi-component or in-mold process.

The base element is preferably formed from aluminum (Al), polyethylene (PE), polypropylene (PP), polyvinyl chloride (PVC), polymethyl methacrylate (PMMA), polycarbonate (PC), polystyrene (PS), polyphenylene ether (PPO) and/or polyethylene terephthalate (PET). The lid element, in particular the lid film, is preferably formed from aluminum (Al), polyethylene (PE), polypropylene (PP), polyvinyl chloride (PVC), polymethyl methacrylate (PMMA), polycarbonate (PC), polystyrene (PS), polyphenylene ether (PPO) or polyethylene terephthalate (PET). Particularly preferably, the lid element, in particular the lid film, is provided in multi-layer form, wherein, very particularly preferably, at least one layer comprises an aluminum material. The lid element preferably comprises a plastics/aluminum composite film or a plastics film or a multilayer plastics film.

Alternatively, the base element and/or the lid film is completely or partially manufactured from a compostable or biodegradable material, which preferably comprises cellulose, PLA (polylactic acid), maize or the like. Preferably, the base element is produced from paper. It is conceivable that the material comprises cellulose fibers embedded in a resin matrix.

It is conceivable that the lid film and the base element are at least partially composed of the same material.

The base element is preferably designed to be frustoconical, conical, cylindrical, spherical, hemispherical, elliptical or semi-elliptical. The base element is preferably designed to be rigid or semi-rigid. The cavity formed by the base element serves for receiving beverage raw material, for example roasted coffee granules, instant coffee, chocolate powder, tea cuttings, milk powder and/or the like. The lid element is formed flat or almost flat, in particular at least one point in time, in particular immediately after closing of the filled single-serve capsule by way of the lid film. Any bowing of the lid element over time due to outgassing of the beverage raw material is insignificant.

It is conceivable that the single-serve capsule is formed rotationally symmetrically about its central axis. The central axis thus forms a central rotational axis of symmetry, which runs centrally through the single-serve capsule and in particular substantially perpendicular to a main plane of extent of the lid element. The flange of the base element preferably runs at an angle of between 70 to 110 degrees, particularly preferably of 80 to 100 degrees and very particularly preferably of substantially 90 degrees to the central axis. The flange is formed circumferentially, in particular in a closed manner. The free, outer end of the flange preferably has a bead, a crimping or a so-called rolled edge to avoid injury to the user at the sharp-edged end.

The single-serve capsule may contain one or more beverage raw materials. The beverage raw material may be a liquid, a syrup, a solid, a powder, a coffee or cocoa substitute, tea leaves or a combination thereof. The beverage raw material may be diluted or extracted in a beverage preparation machine and/or in a beverage preparation system to produce a beverage.

The present invention furthermore relates to a beverage preparation system comprising a beverage preparation machine and a single-serve capsule according to the invention, wherein the beverage preparation machine has a brewing chamber receiving the single-serve capsule, wherein the beverage preparation machine has a detector for detecting the optically detectable identification code, wherein the beverage preparation machine has a first piercing means which is arranged centrally in the brewing chamber and is selectively movable between a retracted position and an extended position, wherein the first piercing means, in the extended position, pierces the lid element of the single-serve capsule, wherein the first piercing means comprises a hollow needle through which, in the extended position, a pressurized liquid can be supplied to the cavity of the single-serve capsule, wherein the beverage preparation machine comprises a second movable piercing means, wherein the second piercing means is designed in such a manner that it perforates the lid element in a region which is spaced apart radially from the central axis and is provided in particular in the vicinity of the flange, for forming at least one beverage outlet.

The beverage preparation system according to the invention is particularly advantageous since the identification code of the single-serve capsule can be read by means of the detector, even if the identification code is not arranged on the flange or the lid element is not fastened to the flange.

The advantages explained relating to this subject matter of the present invention and the associated embodiments also apply mutatis mutandis to the other subject matter of the present invention and vice versa.

Preferably, the first and the second piercing means are formed substantially independently of each other. Particularly preferably, the beverage preparation machine is designed such that the first piercing means first perforates the lid element of the single-serve capsule in a central piercing region, wherein the first piercing means remains in the extended position for feeding the liquid, in particular during the beverage preparation, wherein then the second piercing means perforates the lid element in an outer, preferably substantially circular region, in particular in the vicinity of the flange, and is then moved back into the retracted position such that the beverage can escape unhindered through the resultantly formed beverage outlet openings.

According to a preferred embodiment of this subject matter of the present invention, it is provided that the brewing chamber for preparing a beverage is rotatable about a central axis. This makes it advantageously possible that the liquid introduced into the cavity under pressure flows through the beverage raw material, forming the beverage, and the beverage flows back in the direction of the lid element owing to the centrifugal forces along the capsule wall and exits out of the beverage outlet openings.

Preferably, the detector is provided in such a way that the optically detectable identification code is read before, during and/or after the rotation of the brewing chamber and/or the single-serve capsule. This provides a particularly flexible beverage preparation machine in a particularly advantageous manner.

The present invention furthermore relates to the use of a single-serve capsule according to the invention for preparing a beverage with the aid of a beverage preparation machine, in particular in a beverage preparation system according to the invention.

The advantages explained relating to this subject matter of the present invention and the associated embodiments also apply mutatis mutandis to the other subject matter of the present invention and vice versa.

The present invention furthermore relates to a method for producing a single-serve capsule, in particular a single-serve capsule according to the invention, wherein, in a first step, a base element with a bottom region, an encircling flange at an end opposite the bottom region, and a capsule wall extending from the bottom region to the encircling flange is provided, wherein the base element forms a cavity for receiving a beverage raw material, wherein, in a second step, a lid element is connected to the base element in such a manner that it closes the cavity, wherein an optically detectable identification code is provided on the flange and/or on the lid element.

This makes it possible in a particularly advantageous manner for a single-serve capsule to be provided in which it is not simultaneously the case that the identification code is arranged on the flange and the lid element is fastened to the flange. This advantageously avoids adverse effects on or damage to the flange and/or the identification code during the production of the single-serve capsule and/or during the use of the single-serve capsule.

The advantages explained relating to this subject matter of the present invention and the associated embodiments also apply mutatis mutandis to the other subject matter of the present invention and vice versa.

According to a preferred embodiment of this subject matter of the present invention, it is provided that a lid element which is at least partially rigid and/or is rigid at least in certain regions is connected, in particular in an integrally bonded manner, to the base element in such a manner that a flange region extending radially inward from the capsule wall is formed. Particularly preferably, the lid element projects radially beyond the flange. Very particularly preferably, the identification code is provided on the lid element, in particular in the region projecting beyond the flange. This makes it advantageously possible to provide a single-serve capsule with an optically detectable identification code in which the identification code is not provided on the flange. For example, the lid element may be glued and/or sealed to the flange. In particular, in the case of fastening by means of pressure and/or heat, it is possible to deform the base element, in particular the flange, in the contact region in such a way that a flange region directed toward the cavity is produced. This is particularly advantageous since a larger fastening surface is thus available and thus a secure connection of the lid element to the base element is made possible.

According to a preferred embodiment of this subject matter of the present invention, it is provided that an enclosure element, in particular in the form of a shrink film cover, is pulled over the flange and the lid element from the outside and is then shrunk, in particular by action of heat, in such a manner that the lid element is securely fixed to the flange. This makes it advantageously possible for a flange and lid element to be connected to each other by a separate element or to be fixed at least in their relative position to each other. Of course, other enclosure elements are also conceivable. It is crucial that a separate element is thus pulled over the flange and lid element and fixed. For example, the enclosure element is glued to the flange and/or to the lid element at least in certain sections. Particularly preferably, the enclosure element is transparent at least in certain regions. This makes it advantageously possible for the identification code to be provided on the flange in a known manner, but the enclosure element enables it to continue to be readable. The fact that the flange and the lid element are not connected directly to each other advantageously prevents an adverse effect on the identification element.

Further details, features and advantages of the single-serve capsule, the beverage preparation system, the use or the method will emerge from the drawings and from the following description of preferred embodiments with reference to the drawings. Here, the drawings merely illustrate exemplary embodiments of the single-serve capsule, which do not restrict the essential inventive concept.

### BRIEF DESCRIPTION OF THE DRAWINGS

FIG. 1a shows a perspective view of a single-serve capsule according to an exemplary first embodiment of the present invention.

FIG. 1b shows a side view of the single-serve capsule according to the exemplary first embodiment of the present invention.

FIGS. 2a-d show schematic side views of a single-serve capsule according to various exemplary embodiments of the present invention.

FIG. 3 shows a schematic diagram of the use of a single-serve capsule in a beverage preparation machine for preparation of a beverage according to an exemplary embodiment of the present invention.

FIG. 4 shows a schematic cross section of a single-serve capsule according to an exemplary second embodiment of the present invention.

FIG. 5 shows a schematic cross section of a single-serve capsule according to an exemplary third embodiment of the present invention.

FIG. 6 shows a schematic cross section of a single-serve capsule according to an exemplary fourth embodiment of the present invention.

FIGS. 7a-b show a schematic cross section of a single-serve capsule according to an exemplary fifth embodiment of the present invention at two different times during the production of the single-serve capsule.

FIG. 8 shows a schematic cross section of a single-serve capsule according to an exemplary sixth embodiment of the present invention.

FIG. 9 shows a schematic cross section of a single-serve capsule according to an exemplary seventh embodiment of the present invention.

FIG. 10 shows a schematic cross section of a single-serve capsule according to an exemplary eighth embodiment of the present invention.

FIG. 11 shows a schematic cross section of a single-serve capsule according to an exemplary ninth embodiment of the present invention.

FIG. 12 shows a schematic cross section of a single-serve capsule according to an exemplary tenth embodiment of the present invention.

FIG. 13 shows a schematic cross section of a single-serve capsule according to an exemplary eleventh embodiment of the present invention.

### DETAILED DESCRIPTION

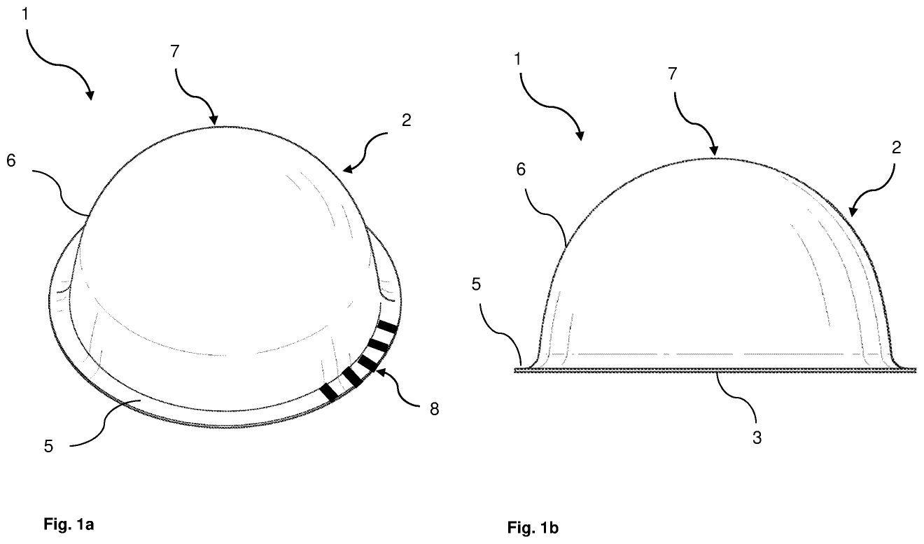

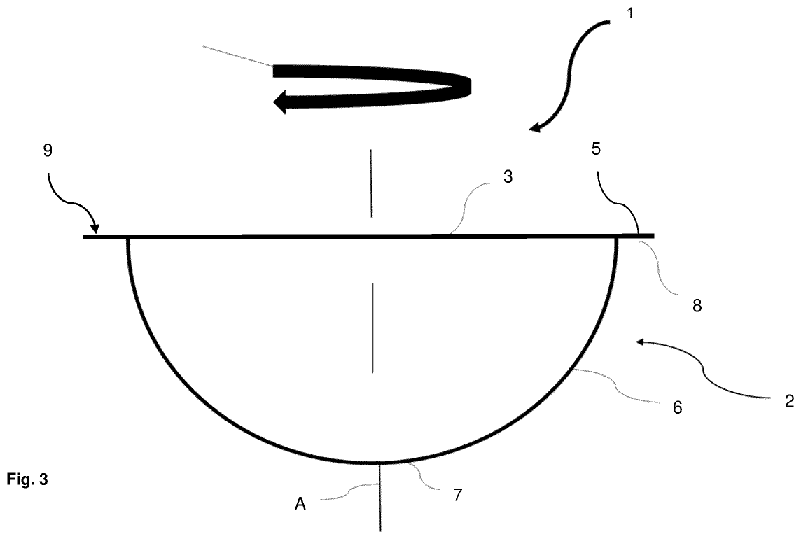

FIG. 1a illustrates a perspective view of a single-serve capsule 1 according to an exemplary first embodiment of the present invention. The single-serve capsule 1 is provided for use in a beverage preparation machine for preparing a beverage, in particular by passing a liquid through the single-serve capsule 1. Such a use will be described in connection with FIG. 3.

In addition, a side view of the single-serve capsule 1 according to the exemplary first embodiment of the present invention is illustrated in FIG. 1b.

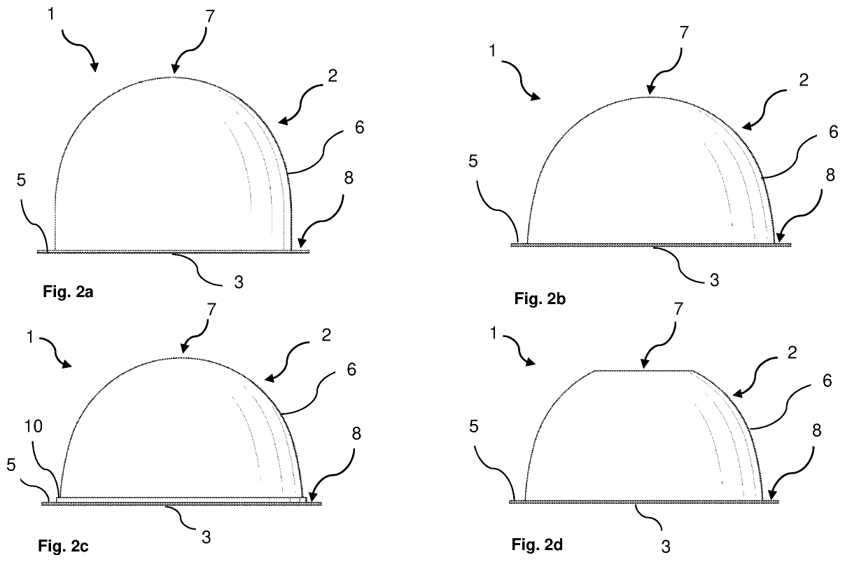

The single-serve capsule 1 has a base element 2. The base element 2 comprises a capsule wall 6 (also referred to as a capsule (side) wall or side wall). The capsule wall 6 extends from a bottom region 7 (also referred to as capsule bottom) as far as an encircling flange 5, which protrudes laterally and in particular is designed to be encircling. The bottom portion 7 preferably merges fluently into the capsule wall 6. However, alternative embodiments, in which a clear separation between the bottom region 7 and the capsule wall 6 is possible, are also explained in connection with FIGS. 2a-d. According to the embodiment illustrated here, the base element 2 is substantially hemispherical.

The base element 2 spans a cavity which is provided for receiving beverage raw material, for example roasted and ground coffee. On the side facing away from the bottom region 7, the base element has a filling opening through which the cavity can be filled with the beverage raw material.

The preferred use of the single-serve capsule 1 according to the invention comprises rotating the single-serve capsule 1 about its central axis A running centrally through the single-serve capsule 1. In order to ensure a rotation which is as free of interference as possible, the single-serve capsule 1 and in particular the base element 2 are preferably formed rotationally symmetrically about the central axis A.

Between the bottom portion 7 and the flange 5, the capsule wall 6 extends around the cavity. In the radial direction, with respect to the central axis A, the radial direction being aligned perpendicularly to the central axis A, the flange 5, which is circular and thus formed in an encircling manner in the circumferential direction, protrudes outward over the capsule wall 6.

The flange 5 is usually fixedly connected to a lid element (also referred to as a capsule lid or membrane), here for example in the form of an in particular circular lid film 3, wherein the lid film 3 closes the cavity on the open side of the base element 2, preferably hermetically. For this purpose, the flange 5 preferably has a sealing plane which faces the lid film 3 and extends substantially at a right angle to the central axis A. At least in some embodiments, the lid film 3 is sealed, welded or glued in its edge region to the flange 5 and in particular on the sealing plane, i.e. is connected to said flange in an integrally bonded manner.

The cavity is filled with the beverage raw material, for example roasted coffee granules, roasted and ground coffee powder, instant coffee, chocolate powder, tea cuttings, milk powder and/or the like (the beverage raw material is not illustrated for the sake of clarity) and is closed by the lid film 3 in an air-tight manner.

In order to permit control of the beverage preparation machine and in particular to ensure compatibility between the beverage preparation machine and the single-serve capsule 1, the single-serve capsule 1 comprises an optically detectable identification code, which takes the form of a barcode 8 here by way of example. Usually, this identification code is provided on the underside, i.e. the side of the flange 5 facing away from the lid film 3 and/or the side of the flange 5 facing the bottom region 7. The barcode 8 here is a customary barcode. The barcode 8 may be provided, as indicated here, only in a circumferential portion, it may be provided in a plurality of circumferential regions preferably uniformly spaced apart from one another, or it may be provided in a completely encircling manner. The barcode 8 is preferably printed on, embossed on or produced in some other way permitting optical detection by an (optical) detector of the beverage preparation machine.

In FIGS. 1 and 2, the single-serve capsule 1 is oriented in such a way that the underside of the flange points upward in the plane of the drawing, i.e. the single-serve capsule 1 is illustrated horizontally on the lid film 3. However, the usual orientation which is in particular also used in FIGS. 3 to 13 and referenced in the context of the present description is reversed, i.e. the bottom region 7 is at the bottom and the filling side which is closed by the lid film 3 is at the top.

A common production method for such a single-serve capsule makes provision, for example, for the barcode 8 to be printed on the underside of the flange and for the lid film 3 to be sealed to the flange 5 before or afterwards. The sealing may directly destroy or damage the barcode 8 and/or the flange may be adversely affected in such a way, for example by mechanical action, heat, pressure and/or radiation, that the structural properties, for example the surface roughness, of the flange is disadvantageously adversely affected. This jeopardizes error-free detection of barcode 8.

It is therefore desirable to optionally provide the barcode 8 on another element or at least not to fasten the lid film 3 to the flange.

FIGS. 2a-d illustrate schematic side views of a single-serve capsule 1 according to various exemplary embodiments of the present invention. The advantage of preparation of a beverage by centrifugation is that the flange and lid film region of the single-serve capsule 1 are technically especially crucial, but the shape of the base element 2 may be substantially freely selected. In particular, this allows a multiplicity of different sizes, i.e. extents of the single-serve capsule 1 along the central axis A. This results in different volume capacities of the respective cavities. For example, different beverages and/or beverage intensities are thus possible.

FIGS. 2a and 2b, for example, show two embodiments with substantially similarly shaped base elements 2, but different axial lengths and therefore different volumes. In both cases, the base element 2, in particular the bottom region 7 and at least parts of the capsule wall 6, are substantially hemispherical. The single-serve capsule 1 shown in FIG. 2a, however, has a base element which, adjacent to the flange 5, has a capsule wall section running substantially rectilinearly and in particular perpendicularly to the flange 5. The single-serve capsule 1 illustrated in FIG. 2c in turn has a step 10 between the capsule wall 6 and the flange 5. This step 10 is preferably part of the capsule wall 6. FIG. 2d, in turn, illustrates an embodiment in which the bottom region 7 is flat. The bottom region 7 thus comprises a main plane of extent, which is preferably oriented parallel to the main plane of extent of the flange 5 and/or of the lid film 3.

FIG. 3 illustrates a schematic diagram of the use of a single-serve capsule 1 in a beverage preparation machine for preparation of a beverage according to an exemplary embodiment of the present invention. The single-serve capsule 1 is intended to be introduced into a brewing unit of a beverage preparation machine to produce a beverage. The brewing unit comprises a first brewing chamber part and a second brewing chamber part, wherein the first and the second brewing chamber part are movable, in particular pivotable or displaceable, relative to each other between a converged position, in which the first and the second brewing chamber part form a closed brewing chamber, and an open position, in which the first and the second brewing chamber part are spaced apart from each other for inserting or ejecting the single-serve capsule 1. Purely for the sake of completeness, it is noted in this context that, despite the designation “brewing unit” and “brewing chamber”, preparations of beverages that do not in the strict sense include brewing and/or extraction are also covered and intended. In particular, dissolving with warm and/or cold water is also covered.

For the preparation of a beverage, a single-serve capsule 1 is inserted into the brewing unit in the open position and the brewing unit is closed. A first piercing means is moved in a central area, preferably exactly in the center, i.e. in an extension of the central axis A, from a retracted position into an extended position. The first piercing means pierces the lid film 3. For the sake of clarity, the beverage preparation machine and its components are not shown in the figures.

The first piercing means preferably comprises a hollow needle and/or an injection needle through which a liquid, in particular water heated and under pressure, for example between 5 and 20 bar, is injected into the cavity. The liquid (also referred to as brewing liquid) passes through the beverage raw material and forms a beverage in interaction therewith.

A second piercing means, which preferably comprises at least one piercing blade, in particular a plurality of piercing blades arranged in the form of a ring, and in particular arranged substantially along a circular ring in the vicinity of the flange 5, are moved from a retracted into an extended position such that they cut the lid film locally, with beverage outlet openings being formed, and move back into the retracted position so as not to block the beverage outlet openings.

The single-serve capsule 1 and/or the brewing unit is/are now rotated about the central axis A, preferably by a drive, such as an electric motor. The liquid and/or the beverage are/is thereby ejected outward by centrifugal forces in the direction of the capsule wall 6 and then from there upward along the capsule wall 6. The finished beverage then exits through the beverage outlet openings and can be directed there toward a beverage outlet of the beverage preparation machine.

Alternatively or in addition to the lid film 3, the bottom portion 7 may be perforated in the closed position to create a perforation opening for introducing liquid or for discharging the beverage which has been produced.

By means of an optional filter medium, any particles of the beverage raw material can be filtered out of the beverage and retained in the single-serve capsule 1. Preferably, however, the in particular multiply perforated lid film 3 acts as a filter element.

The single-serve capsule 1 now has an identification code which is optically detectable in particular by a detector of the beverage preparation machine. This identification code is preferably used to be able to identify the single-serve capsule 1 in the beverage preparation machine and/or to control brewing parameters. Thus, the beverage preparation machine can verify, for example, whether the single-serve capsule 1 located in the brewing chamber is a compatible single-serve capsule 1, and/or a suitable brewing program for the beverage raw material located in the single-serve capsule 1 can be automatically selected and started. It is also conceivable that brewing parameters to be used specifically, such as the water temperature, the amount of water, the water pressure and/or the rotational speed of the single-serve capsule 1 during the brewing, are embedded in the optically detectable identification code and are read by means of the detector.

The optically detectable identification code is in particular a machine-readable code in the form of a one-dimensional or multi-dimensional bit code or barcode 8. The bit code or barcode 8 is formed in this case in a completely or partially encircling manner as a circle or partial circle about the central axis A of the single-serve capsule 1. The individual adjacent lines, from which the in particular two- or multi-colored bit code or barcode 8 is constructed, then preferably extend in the radial direction and are arranged side by side in the circumferential direction. The barcode 8 is arranged in particular on one side (also referred to as the underside) of the flange 5, which side faces away from the lid element, in particular the lid film 3 here.

The base element 2 and the lid film 3 are preferably made of aluminum (Al), polyethylene (PE), polypropylene (PP), polyvinyl chloride (PVC), polymethyl methacrylate (PMMA), polycarbonate (PC), polystyrene (PS), polyphenylene ether (PPO) and/or polyethylene terephthalate (PET), in particular in a single- or multi-layer manner. The pot-shaped or spherical configuration of the base element 2 is preferably produced by thermoforming, for example deep drawing by means of negative pressure, positive pressure and/or a movable die. Alternatively, the single-serve capsule is produced by means of an injection molding process, in particular in a one-component, multi-component or in-mold process. As a further alternative, it would be conceivable that the base element 2 and/or the lid film 3 are/is produced completely or partially from a biodegradable material, in particular from cellulose fibers, which are preferably embedded in a resin matrix.

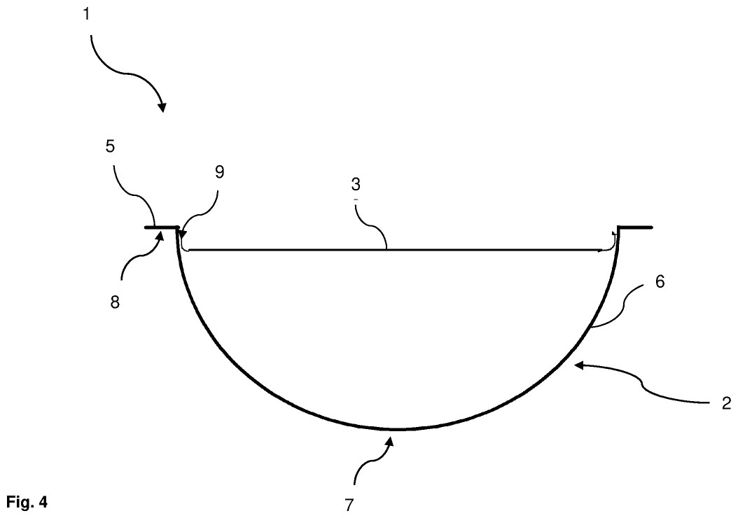

FIG. 4 shows a schematic cross section of a single-serve capsule 1 according to an exemplary second embodiment of the present invention. In order to avoid the problems already explained for the single-serve capsules of the type in question, the lid film 3 is not fastened to the flange 5, but rather to the inside of the capsule wall 6. This is particularly preferably achieved by (ultrasonic) sealing, for example with a sonotrode, which inserts the lid film 3 into the cavity for a certain distance, wherein, during the insertion, an edge region of the lid film 3 nestles against the capsule wall 6, and then seals the lid film 3 laterally against the capsule wall 6. The sealing is carried out in particular in at least one fastening region 9. The latter is preferably provided in a completely encircling manner. Alternatively, however, it is also possible for a multiplicity of fastening regions which are spaced apart from one another in the circumferential direction to be provided. Here, the fastening region 9 is now arranged above the main plane of extent of the lid film 3.

In this case, the barcode 8 can be provided on the underside of the flange in the usual manner, since the flange 5 is not adversely affected by the fastening of the lid film 3.

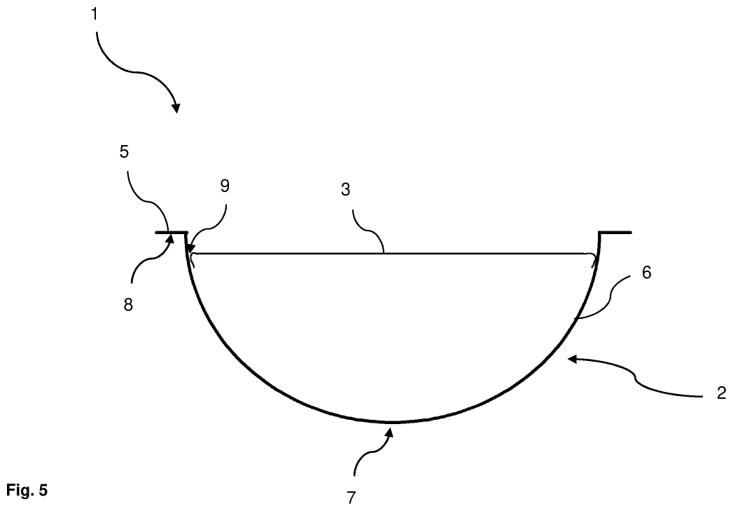

FIG. 5 illustrates a further schematic cross section of a single-serve capsule 1 according to an exemplary third embodiment of the present invention, said third embodiment resembling the second embodiment. Here too, the lid film 3 is fastened laterally to an inside of the capsule wall 6. However, the fastening region 9 is now arranged here below the main plane of extent of the lid film 3. For this purpose, the lid film can be fixed, for example, from the outside by the capsule wall 6. Alternatively or additionally, an edge region of the lid film is bent over before insertion into the base element 2 and coated with an adhesive, for example, and inserted. It is conceivable that the adhesive- or an alternative integrally bonded connecting means—is activated from the outside by the action of energy, for example targeted heating and/or irradiation.

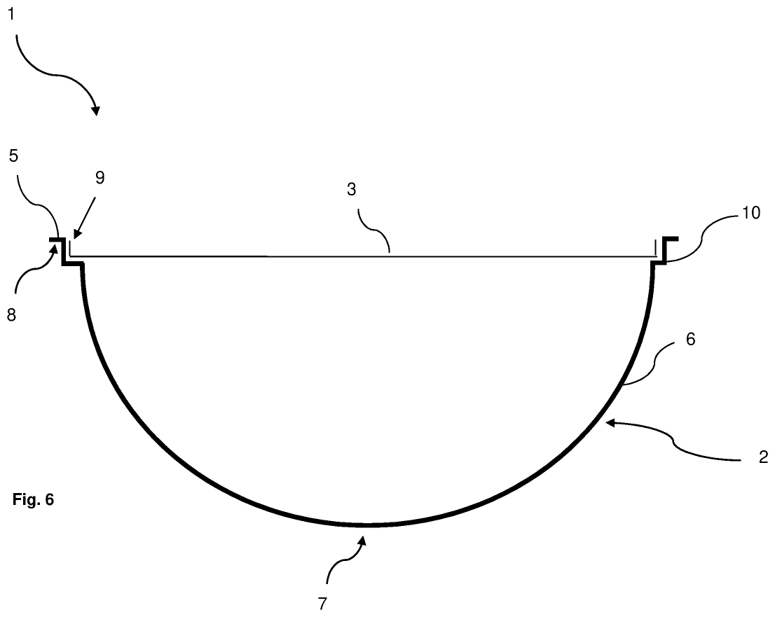

The single-serve capsules 1 according to the embodiments of FIGS. 4 and 5 have the disadvantage that the fastening height of the lid film 3 can be difficult to control. However, this in turn is disadvantageous since reliable piercing by the first and/or the second piercing means cannot be ensured. FIG. 6 therefore illustrates a schematic cross section of a single-serve capsule 1 according to an exemplary fourth embodiment of the present invention. Here, the base element 2 has a step 10 in the capsule wall 6 below the flange 5. This step 10 makes it advantageously possible to ensure an exact positioning of the lid film 3. The step 10 has an encircling shoulder formed substantially parallel to the flange 5, i.e. an in particular horizontal shoulder, and a preferably approximately vertically aligned capsule wall region between the shoulder and the flange 5. Particularly preferably, the lid film 3 is fastened, in particular sealed, laterally to the vertical capsule wall region. That is, the fastening region 9 is at least partially provided in the vertical capsule wall region. In addition or alternatively, fastening may also take place at the horizontal shoulder. Here too, the barcode 8 may be located on the underside of the flange. In addition, however, it is advantageously possible to precisely position the lid film 3 via the dimensioning of the step 10.

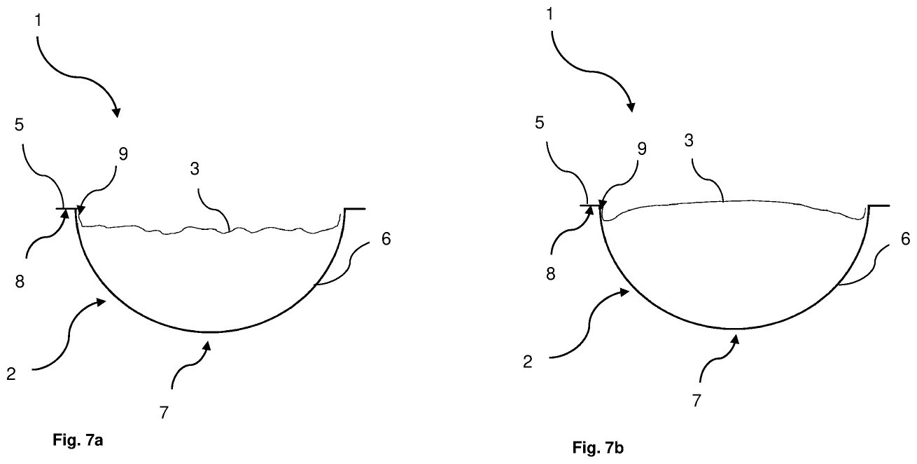

FIGS. 7a-b illustrate schematic cross sections of a single-serve capsule 1 according to an exemplary fifth embodiment of the present invention at two different times during the production of the single-serve capsule 1. FIG. 7a illustrates the situation immediately before and/or after the fastening of the lid film 3. Once again, the lid film is fastened in an edge region on the inside of the capsule wall 6. However, the lid film 3 is now particularly elastic and/or has a material reservoir. This should be understood as meaning in particular that the lid film is not tensioned in the fastened state. A local inner diameter of the single-serve capsule 1 is defined at the intersection of the main plane of extent of the lid film 3 with the capsule wall 6. This also results in a cross-sectional area at this point. The lid film 3 now has in particular an effective surface, which is larger than said cross-sectional area.

This embodiment is particularly suitable for beverage raw materials, such as roasted and ground coffee, which outgas after the single-serve capsule 1 is filled. In the case of coffee, carbon dioxide is produced by chemical processes in the coffee. This now leads to bowing of the lid film 3, i.e. the lid film 3 is bulged outward by the resulting gas. This is illustrated in FIG. 7b. The effect advantageously achieved by this is that the lid film can be easily fastened to the inside of the capsule wall 6, in particular in such a way that the fastening region 9 lies above the main plane of extent of the lid film 3, but at the time of use of the single-serve capsule 1, the lid film is located higher in the piercing region to be perforated by the first piercing means and preferably also in the piercing region to be perforated by the second piercing means, preferably on the plane of the flange 5. The barcode 8 may also be provided again here on the underside of the flange.

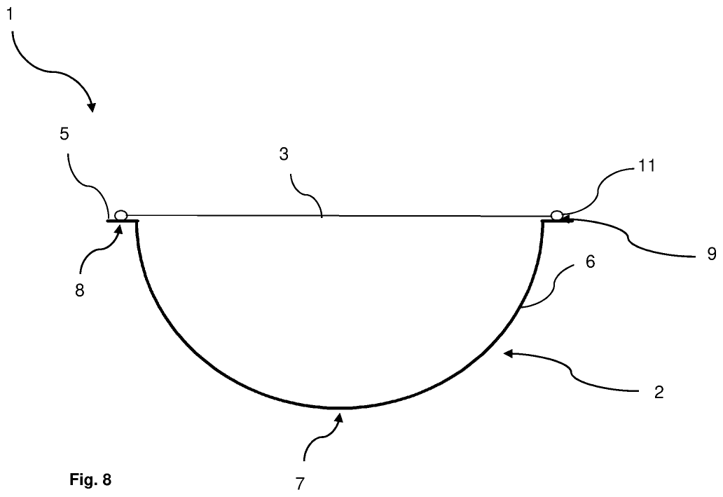

FIG. 8 illustrates a schematic cross section of a single-serve capsule 1 according to an exemplary sixth embodiment of the present invention. In comparison to the previously explained embodiments, this one provides for a different fastening region 9.

In the present case, the single-serve capsule 1 comprises an annular element 11, i.e. a preferably annularly encircling element which is arranged substantially at the height (in the radial direction) of the flange 5. For example, this annular element 11 may be part of the lid element. The annular element 11 may be formed in one piece or multiple pieces with the lid element. Preferably, it is at least partially formed from the same material.

The annular element 11 may have a multiplicity of possible (radial) cross sections, but preferably a rectangular, square, circular, elliptical or oval cross section.

Here, for example, a lid film 3 is tensioned within the annular element 11. However, it is also possible for the annular element 11 to have a smaller diameter than the lid film 3 or the lid element and to be inserted therein.

It is now crucial that the lid element is connected to the flange 5 via the annular element 11. That is to say that the annular element 11 is fastened to the flange 5. The annular element 5 is manufactured, for example, from a comparatively soft material, at least in the fastening region. The lid element is thus only fastened indirectly to the flange 5 and the annular element 11 is designed in particular in such a way that fastening takes place in a material-friendly manner. By means of the fastening of the annular element 11 to the flange 5 in the fastening region 9, the flange 5 is thus not adversely affected or at least is adversely affected to a significantly lesser extent. The barcode 8 can therefore be fastened again to the underside of the flange, since indirect fastening is carried out via the annular element 11. For example, the annular element 11 may be formed in such a way that it absorbs deformation energy and, as a result, structural damage to the barcode 8 and/or to the flange 5 is avoided.

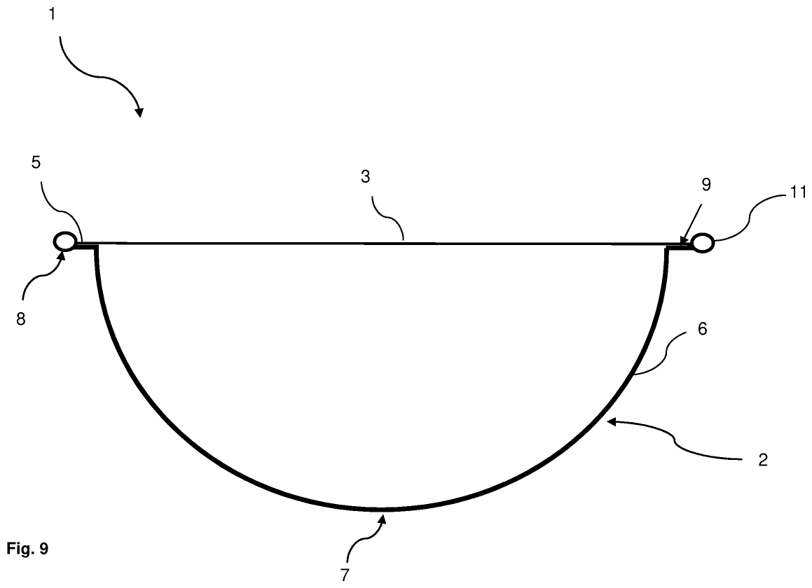

FIG. 9 illustrates a schematic cross section of a single-serve capsule 1 according to an exemplary seventh embodiment of the present invention, which is similar to the embodiment explained previously in connection with FIG. 8. Here too, the single-serve capsule 1 comprises an annular element 11. However, this annular element 11 now has a diameter which is larger than the diameter of the flange 5. The flange 5 preferably also has a smaller diameter here than in the case of single-serve capsules 1 of the type in question.

According to this embodiment, the barcode 8 is provided on the annular element 11, in particular on the underside thereof. The lid element, for example a lid film 3, can thus be fastened here to the flange 5, as a result of which the fastening region 9 substantially coincides with the top side of the flange. Particularly preferably, the lid film 3 is fixedly connected to the annular element 11, in particular is formed in one piece therewith. Very particularly preferably, the annular element 11 has a substantially horizontal surface on its underside at least in the region in which the barcode 8 is arranged.

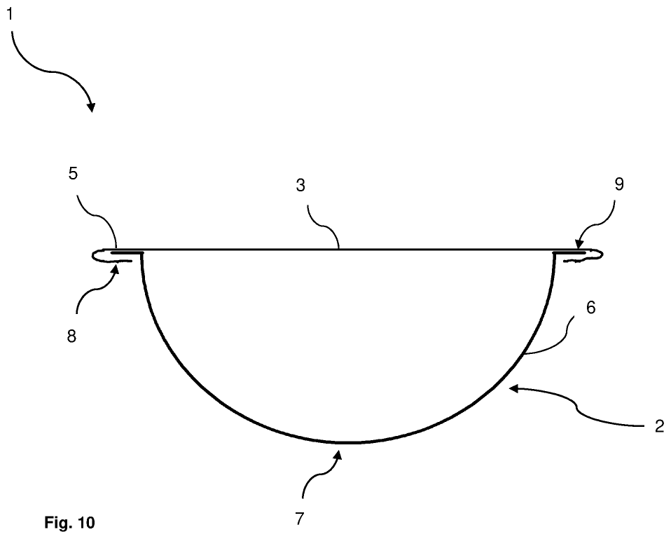

FIG. 10 illustrates a schematic cross section of a single-serve capsule 1 according to an exemplary eighth embodiment of the present invention. According to this embodiment, the lid film 3 has a significantly larger diameter than the flange 5. During the production of the single-serve capsule, after filling of the cavity with the beverage raw material, the lid film 3 is placed onto the flange 5 and folded around the latter such that the lid film 3 also rests on the underside of the flange 5. The lid film 3 can now be connected to the underside and/or the top side of the flange 5. Preferably, the barcode 3 is printed here on the lid film 3 in such a way that the barcode is oriented after the fastening of the lid film 3 on the underside of the flange and in the direction of the bottom region 7.

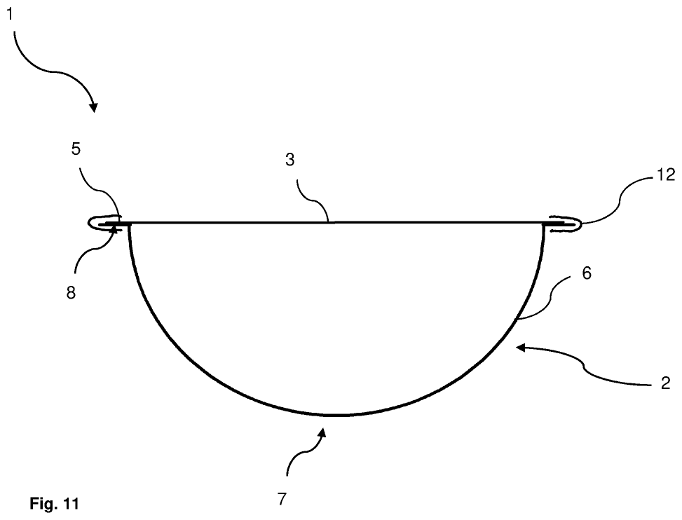

FIG. 11 illustrates a schematic cross section of a single-serve capsule 1 according to an exemplary ninth embodiment of the present invention. In this case, the single-serve capsule 1 additionally comprises an enclosure element 12. The latter is provided, for example, in the form of a sheath, for example with an approximately U-shaped cross section, and is pulled from the outside over the flange 5 such that it covers at least partially the flange 5 on the underside and covers the lid film 3 on the top side at least in certain regions. The enclosure element is now fixed in such a way that it fixes the lid film 3 and flange 5 in their relative position with respect to each other. Flange 5 and lid film 3 are thus indirectly connected to each other. For example, the enclosure element 12 is provided as a shrink film covering made from a suitable plastics film. After application, the enclosure element 12 is shrunk and thus adheres firmly to flange 5 and lid film 3.

The enclosure element 12 is now transparent at least on the underside of the flange, and therefore the detector can detect a barcode 8 provided on the underside of the flange through the enclosure element 12, and/or the barcode 8 is provided on the underside of the enclosure element 12. Since flange 5 and lid film 3 are not connected directly to each other, there is also no threat of damage to the flange 5 or the barcode 8, and therefore the barcode 8 may also be safely arranged on the underside of the flange.

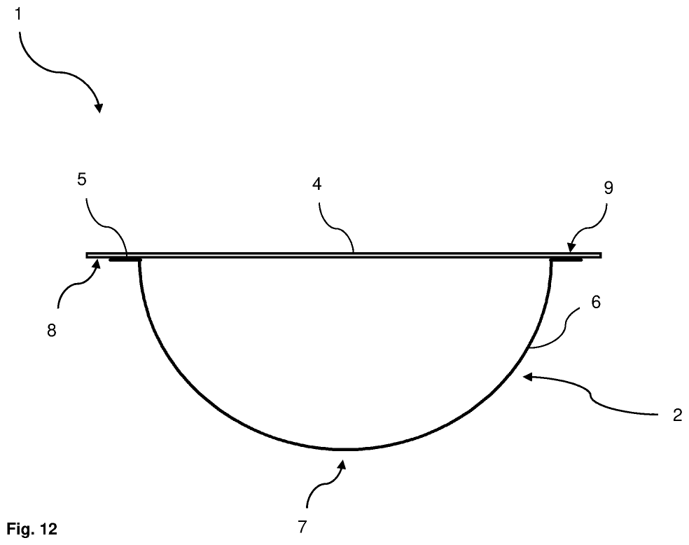

FIG. 12 illustrates a schematic cross section of a single-serve capsule 1 according to an exemplary tenth embodiment of the present invention. The single-serve capsule 1 of this embodiment does not have a lid film 3 in the narrower sense, i.e. does not have a substantially flexible film, but rather has a lid element 4 which is at least partially rigid and/or is rigid at least in certain regions. The lid element 4 is sufficiently flexible and/or elastic at least in the piercing regions that error-free functioning of the piercing means is ensured, but has sufficient intrinsic stability, in particular in the radially outer region, such that a region of the lid element 4 which is not mounted on the flange 5 maintains a substantially horizontal position. The barcode 8 is provided here on the underside of the lid element 4, in particular in a region projecting beyond the flange 5.

The lid element 4 can now be fastened in the usual manner to the flange 5 since the radially outer barcode 8 is not adversely affected by the fastening. In addition, it is possible that other fastening methods can be used owing to the relatively rigid lid element compared to a film. For example, the lid element 4 is adhesively bonded to the flange 5.

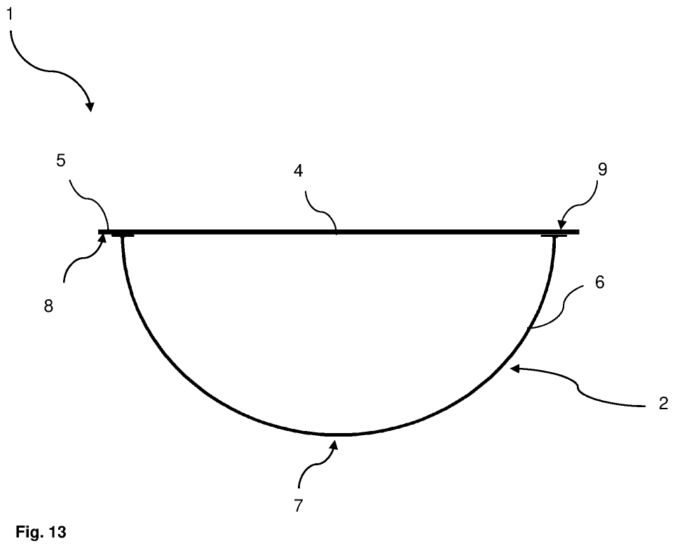

FIG. 13 shows a schematic cross section of a single-serve capsule 1 according to an exemplary eleventh embodiment of the present invention. In this case, this embodiment corresponds in particular substantially to the previously explained embodiment, which is illustrated in FIG. 12.

Here too, a lid element 4 which is substantially intrinsically stable or rigid at least in a radially outer region is provided. Now, however, the flange 5 comprises not only a radially outwardly protruding region, but also a radially inwardly protruding region, i.e. a region pointing in the direction of the cavity. This can be produced during the production of the base element 2. Alternatively or additionally, it is produced by the action of energy during the fastening of the lid element 4 to the flange 5. Preferably, the inner flange region has a different shape and/or a different radial extent from the outer flange region. For example, under the action of pressure and/or heat, the material of the flange is softened in such a way that a part is displaced radially inward.

Such a widened flange advantageously provides a larger fastening surface and thus a more stable fastening of the lid element 3 to the flange 5 and therefore to the base element 2.

Particularly preferably, the barcode 8 is again provided on the underside of the lid element 4 in a region projecting radially outward beyond the flange 5. Since, in the present case, the flange 5 can be significantly deformed, it is particularly advantageous if the barcode 8 is arranged on the lid element 4 rather than on the flange 5.

### LIST OF REFERENCE SIGNS

1 Single-serve capsule
2 Base element
3 Lid film
4 Rigid lid element
5 Flange
6 Capsule wall
7 Bottom region
8 Barcode
9 Fastening region
10 Step
11 Annular element
12 Enclosure element
A Central axis

1. A single-serve capsule for preparing a beverage with of a beverage preparation machine, the single-serve capsule having a base element with a cavity for receiving a beverage raw material, and a lid element closing the cavity, the base element comprising a bottom region, an encircling flange at an end opposite the bottom region, and a capsule wall extending from the bottom region to the encircling flange, wherein the single-serve capsule has an optically detectable identification code, the optically detectable identification code is arranged on the lid element at least in one or more regions of the lid element where the lid element protrudes radially beyond an outside of the encircling flange, wherein the lid element is rigid at least in regions where the optically detectable identification code protrudes radially outside the encircling flange.

2.-20. (canceled)

21. The single-serve capsule as claimed in claim 1, wherein the lid element that is rigid at least in the regions where the optically detectable identification code protrudes radially outside the encircling flange is connected to the base element such that that a flange region extending radially inward from the capsule wall is formed.

22. The single-serve capsule as claimed in claim 1, where the optically detectable identification code is arranged on a side of the lid element facing the bottom region of the base element.

23. The single-serve capsule as claimed in claim 1, wherein the lid element is fastened to the capsule wall or to an inside of the capsule wall.

24. The single-serve capsule as claimed in claim 1, wherein the single-serve capsule is rotationally symmetrical about a central axis extending centrically through the single-serve capsule.

25. The single-serve capsule as claimed in claim 1, where the lid element is adhesively bonded and/or sealed to the encircling flange.

26. The single-serve capsule as claimed in claim 1, where the lid element has a sufficient inherent stability in such a manner that the one or more regions of the lid element where the lid element protrudes radially beyond the outside of the encircling flange maintains a substantially horizontal alignment.

27. The single-serve capsule as claimed in claim 1, wherein the lid element comprising a piercing region that is configured to be pierced by the beverage preparation machine, wherein the piercing region is located in a central region of the lid element and/or an outer region of the lid element.

28. The single-serve capsule as claimed in claim 1, wherein the lid element is made of one material.

29. The single-serve capsule as claimed in claim 1, wherein the lid element in different regions is made at least partially of different materials.

30. The single-serve capsule as claimed in claim 1, wherein the optically detectable identification code comprises a bit code and/or barcode.

31. A beverage preparation system comprising the beverage preparation machine and the single-serve capsule as claimed in claim 1, wherein the beverage preparation machine comprises: i) a brewing chamber receiving the single-serve capsule; ii) a detector for detecting the optically detectable identification code; iii) a first piercing means arranged centrally in the brewing chamber and is selectively movable between a retracted position and an extended position, wherein, in the extended position the first piercing means is configured to pierce the lid element of the single-serve capsule, the first piercing means comprises a hollow needle through which, in the extended position, a pressurized liquid is supplied to the cavity of the single-serve capsule; and iv) a second movable piercing means configured to pierce the lid element in a region which is spaced apart radially from the central axis and is provided in a vicinity of the encircling flange, for forming at least one beverage outlet.

32. The beverage preparation system as claimed in claim 31, wherein the brewing chamber is configured to rotate about a central axis.

33. Use of the single-serve capsule as claimed in claim 1 for preparing the beverage with the aid of the beverage preparation machine.

34. A method for producing the single-serve capsule as claimed in claim 1 comprising forming base element, connecting the lid element to the base element to close the cavity, and providing the optically detectable identification code on the lid element.

35. The method as claimed in claim 34, wherein the element is connected to the base element in such a manner that a flange region extending radially inward from the capsule wall is formed.
